(19) United States
(12) Patent Application Publication
(10) Pub. No.: US 2016/0299263 A1
(43) Pub. Date: Oct. 13, 2016

(54) MICROLENS ARRAY, MANUFACTURING METHOD THEREOF, IMAGE ACQUISITION DEVICE, AND DISPLAY DEVICE

(71) Applicant: BOE TECHNOLOGY GROUP CO., LTD., Beijing (CN)

(72) Inventor: Chunmiao ZHOU, Beijing (CN)

(21) Appl. No.: 14/776,884

(22) PCT Filed: Mar. 19, 2015
(86) PCT No.: PCT/CN2015/074568

§ 371 Date: Sep. 15, 2015

(30) Foreign Application Priority Data
Oct. 28, 2014 (CN) 201410589941.3

(51) Int. Cl. G02B 3/00; B29D 11/00; G02B 27/22

(52) U.S. Cl. CPC G02B 3/0018; G02B 27/2214; B29D 11/00375; B29D 11/0048; B29D 11/00442; B29K 2995/0031

(57) ABSTRACT

The present invention provides a microlens array, a manufacturing method thereof, an image acquisition device, and a display device. The manufacturing method of a microlens array includes steps of: providing a substrate; forming a plurality of accommodation grooves on the substrate; instilling a colloidal prepolymer into each of the plurality of accommodation grooves, so that a top surface of the prepolymer forms a curved surface protruding outwards; and curing the prepolymer, so that the prepolymer in each of the plurality of accommodation groove is cured to form a microlens unit, thereby obtaining the microlens array. The manufacturing method provided by the present invention is simple, is applicable to a large-scale microlens array, and the manufactured microlens array has better precision and uniformity.

### FIELD OF THE INVENTION

The present invention relates to the field of integral imaging technology, and in particular, relates to a microlens array, a manufacturing method thereof, an image acquisition device, and a display device.

### BACKGROUND OF THE INVENTION

New display technologies are continuously developed along with the advent of the concept of 3D display, and an integral imaging technology is a display technology which reproduces the light field of an object in a space or images an object within a certain spatial range. The integral imaging technology is an all-true 3D stereoscopic display technology and free of conflict between the display principle thereof and the principle of human vision, will not cause the stereoscopic viewing fatigue as before and can perform omnidirectional three-dimensional display, and thus becomes a next generation display technology which attracts increasing attention.

As shown in FIG. 1, an integral imaging technology based on a microlens array is generally a technology which records the spatial scene of an object 11 by using the microlens array and reproduces a 3D image 13 of the spatial scene. In recording, a camera 14 provided with a microlens array records information of the spatial scene of the object 11 from different directions with each microlens unit 12 in the micolens array, so as to generate a micro image array. In reproducing, a microlens array provided on the light-outgoing surface of a display panel 15 converges and restores the light emitted from the micro image array according to the principle of optical reversibility, so as to produce the 3D image 13 of the spatial scene of the object 11.

The microlens array is a crucial device to implement the integral imaging, and the development and performance thereof have direct influence on the development and performance of the integral imaging. A traditional microlens array is mainly manufactured with a grinding tool or by machining, and the processing size and precision thereof is limited by the grinding tool and the machining equipment. Meanwhile, a large-scale microlens array manufactured by using the existing process has the problem of poor precision and uniformity, and cannot meet the requirements for the integral imaging.

### SUMMARY OF THE INVENTION

An object of the present invention is to provide a microlens array, a manufacturing method thereof, an image acquisition device, and a display device, so as to reduce the difficulty of the manufacturing process and increase the precision and uniformity of the manufactured microlens array.

To achieve the above object, the present invention provides a manufacturing method of a microlens array, including steps of:
providing a substrate;
forming a plurality of accommodation grooves on the substrate;
instilling a colloidal prepolymer into each of the plurality of accommodation grooves, so that a top surface of the prepolymer forms a curved surface protruding outwards; and
curing the prepolymer, so that the prepolymer in each of the plurality of accommodation grooves is cured to form a microlens unit, thereby obtaining the microlens array.

Preferably, the step of forming a plurality of accommodation grooves on the substrate includes steps of:
forming a photoresist layer on the substrate; and
etching the substrate by a photolithographic patterning process, so as to form the plurality of accommodation grooves in the substrate.

Preferably, the step of forming a plurality of accommodation grooves on the substrate includes steps of:
forming a photosensitive resin material layer on the substrate; and
performing exposure and development on the photosensitive resin material layer, so as to form the plurality of accommodation grooves in the photosensitive resin material layer.

Preferably, the manufacturing method further includes, before the step of instilling a colloidal prepolymer into each of the plurality of accommodation grooves, a step of:
forming an opaque immiscible layer on a top surface of sidewall of each of the plurality of accommodation grooves.

Preferably, a focal length of the microlens unit is changed by changing any one of shape of each of the plurality of accommodation grooves, volume of the prepolymer in each of the plurality of accommodation grooves, and force of interaction between the prepolymer and the immiscible layer.

Preferably, a material of the immiscible layer includes polystyrene and/or poly(silyl ester)s.

Preferably, a material of the prepolymer includes any one of or a combination of more than one of methacrylate, epoxy acrylate, and silicone acrylate.

Preferably, a viscosity of the prepolymer ranges from 4000 cps to 7000 cps.

Preferably, in the step of curing the prepolymer, the prepolymer is cured by irradiation with ultraviolet light.

Preferably, a material of the photosensitive resin material layer includes any one or a combination of TMPTA and TPGDA.

Correspondingly, the present invention further provides a microlens array, including a substrate, a plurality of accommodation grooves formed on the substrate, and a plurality of microlens units provided in the plurality of accommodation grooves, respectively, each of the microlens units being polymer.

Preferably, the substrate includes a substrate body, and the plurality of accommodation grooves are formed in the substrate body.

Preferably, the substrate includes a substrate body, a photosensitive resin material layer is provided on the substrate body, and the plurality of accommodation grooves are formed in the photosensitive resin material layer.

Preferably, an opaque immiscible layer is provided on a top surface of sidewall of each of the plurality of accommodation grooves.

Preferably, a material of the immiscible layer includes polystyrene and/or poly(silyl ester)s.

Preferably, a material of the prepolymer includes any one of or a combination of more than one of methacrylate, epoxy acrylate, and silicone acrylate.

Preferably, a material of the photosensitive resin material layer includes any one or a combination of TMPTA and TPGDA.

Correspondingly, the present invention further provides an image acquisition device including a camera and a microlens array provided on the camera, wherein, the microlens array is the microlens array provided by the present invention.

Correspondingly, the present invention further provides a display device including a display panel and a microlens array provided on a light-outgoing surface of the display panel, wherein, the microlens array is the microlens array provided by the present invention.

In the present invention, in manufacturing the microlens array, a prepolymer is instilled into each of the accommodation grooves, each droplet of the prepolymer self-assembles to form a protrusion with a curved top surface due to the surface tension of the prepolymer, after being cured, the protrusion cannot flow anymore and can thus maintain a stable shape, in this way, the cured droplet of the prepolymer form a microlens unit, and a plurality of the microlens units form a microlens array. When manufacturing a large-scale microlens array, the manufacturing method according to the present invention is more convenient, without manufacturing related moulds, and results in better precision and uniformity of the microlens array. Furthermore, the microlens array can be formed on a substrate of a display panel, thereby reducing the cost thereof.

### BRIEF DESCRIPTION OF THE DRAWINGS

The drawings are for the purpose of providing better understanding of the present invention, and constitute a part of the description. The drawings are used for explaining the present invention along with the following specific embodiments, rather than limiting the present invention, in the drawings:

FIG. 1 is a schematic diagram showing that an integral imaging system based on a microlens array displays a 3D image in the prior art;

FIG. 2 is a flow chart schematically showing a manufacturing method of a microlens array according to an embodiment of the present invention;

FIG. 3 is a schematic diagram showing a structure of a microlens unit formed in an accommodation groove in an embodiment of the present invention;

FIG. 4 is a schematic diagram showing that a photosensitive resin material layer is formed on a substrate in an embodiment of the present invention;

FIG. 5 is a schematic diagram showing that accommodation grooves are formed in the photosensitive resin material layer in an embodiment of the present invention;

FIG. 6 is a schematic diagram showing that an immiscible layer is formed in an embodiment of the present invention;

FIG. 7 is a schematic diagram showing that a prepolymer is instilled into each of the accommodation grooves in an embodiment of the present invention; and

FIG. 8 is a schematic diagram showing that the prepolymer is cured in an embodiment of the present invention.

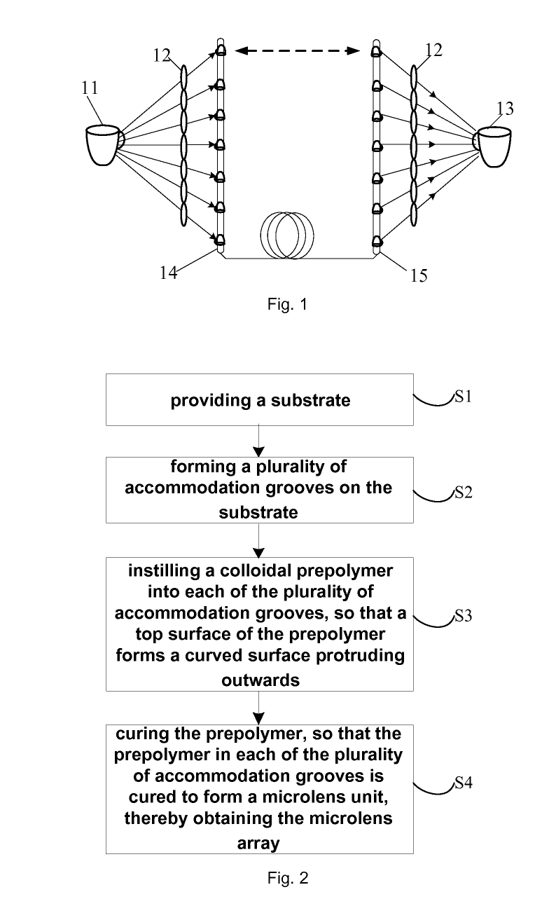

### DESCRIPTION OF REFERENCE NUMERALS

11. Object; 12. Microlens unit; 13. 3D image; 14. Camera; 15. Display panel; 21. Substrate; 22. Accommodation groove; 221. Sidewall of the accommodation groove; 23. Prepolymer; 24. Photosensitive resin material layer; 25. Mask; 26. Immiscible layer.

### DETAILED DESCRIPTION OF THE EMBODIMENTS

Embodiments of the present invention will be described in detail below in conjunction with the drawings. In should be understood that, the embodiments set forth herein are merely for the purpose of describing and explaining the present invention, but not for limiting the present invention.

As an aspect of the present invention, there is provided a manufacturing method of a microlens array, which, as shown in FIG. 2, includes steps of:
providing a substrate 21 (see step S1 in FIG. 2);
forming a plurality of accommodation grooves 22 on the substrate 21 (see step S2 in FIG. 2);
instilling a colloidal prepolymer 23 into each of the plurality of accommodation grooves 22, so that a top surface of the prepolymer 23 forms a curved surface protruding outwards, as shown in FIG. 7 (see step S3 in FIG. 2); and
curing the prepolymer 23, so that the prepolymer 23 in each of the plurality of accommodation grooves is cured to form a microlens unit, thereby obtaining the microlens array, as shown in FIG. 8 (see step S4 in FIG. 2).

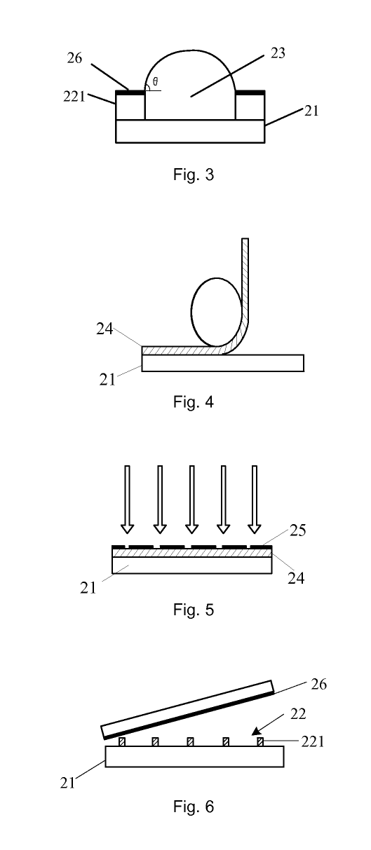

In the present invention, the microlens array is manufactured by way of instilling the prepolymer 23. Specifically, after the colloidal prepolymer 23 is instilled into each of the plurality of accommodation grooves 22, a colloidal droplet of the prepolymer self-assembles to form a protrusion under the effect of surface tension of the colloidal droplet, as shown in FIG. 3. After the prepolymer 23 is cured, the colloidal protrusion is cured to form a stable solid protrusion, i.e., form a microlens unit (the microlens unit is polymer, it is easily understood for a person skilled in the art that, the polymer is formed by polymerizing the prepolymer), thereby forming the microlens array on the substrate. As compared with the method of forming a microlens array with a grinding tool or by machining in the prior art, in the method employed by the present invention, the microlens array is formed by instilling the prepolymer 23 into the accommodation grooves 22 and then curing the prepolymer 23, and thus, the manufacturing process of the microlens array is simple. Further, when manufacturing a large-scale microlens array by using the manufacturing method of the present invention, it only needs to increase the number of the accommodation grooves 22, thus the manufacturing process is simple. In addition, when the shapes of the plurality of accommodation grooves 22 are the same and the amount of the prepolymer instilled into the plurality of accommodation grooves 22 are the same, the shapes of the formed microlens units are also the same, thereby increasing the uniformity of the microlens array; and the substrate in the microlens array may be a glass substrate in a display panel, thereby reducing the manufacturing cost.

In the present invention, the method for forming the accommodation grooves 22 is not limited. The accommodation grooves 22 may be formed on the substrate 21 directly, i.e., the substrate 21 is etched to form grooves which are the accommodation grooves 22. It is also feasible to coat, on the substrate 21, a material for forming sidewalls of the accommodation grooves, and then etch the material to form the accommodation grooves 22.

As a first implementation of the present invention, the step of forming the plurality of accommodation grooves 22 on the substrate 21 includes steps of:
forming a photoresist layer on the substrate 21; and
etching the substrate 21 by a photolithographic patterning process, so as to form the plurality of accommodation grooves 22 on the substrate 21. Specifically, firstly, exposure and development are performed on the photoresist layer with a mask, so as to remove the photoresist corresponding to the positions where the accommodation grooves 22 are to be formed and expose the substrate 21, whereas the photoresist at other positions remains; and then, the exposed portions of the substrate 21 are etched, so as to form the plurality of accommodation grooves 22 in the substrate 21.

The prepolymer 23 is instilled into each of the plurality of accommodation grooves 22 formed in such way, and the prepolymer 23 is cured to form a microlens unit, thereby forming the microlens array in the substrate. The formed microlens array has a small thickness, thus allowing a display panel including the microlens array to have a small thickness. Meanwhile, the substrate 21 may be a glass substrate which has a high strength, resulting in that the formed microlens unit is stable and is not ease to be damaged.

As a second implementation of the present invention, the step of forming the plurality of accommodation grooves 22 on the substrate 21 includes steps of:
forming a photosensitive resin material layer 24 on the substrate 21, as shown in

FIG. 4, wherein the photosensitive resin material layer 24 may be the photoresist layer in the first implementation; and
performing exposure and development on the photosensitive resin material layer 24, so as to form the plurality of accommodation grooves 22 in the photosensitive resin material layer 24. Specifically, as shown in FIG. 4, the photosensitive resin material layer 24 is coated on the substrate 21, and then the photosensitive resin material layer 24 is exposed with a mask 25. Light non-transmissive regions of the mask 25 correspond to the positions where the accommodation grooves 22 are located, and light transmissive regions of the mask 25 correspond to the positions of sidewalls of the accommodation grooves 22 (as shown in FIG. 5), so that the photosensitive resin material layer 24 corresponding to the positions of the accommodation grooves 22 is denatured after being exposed, and the denatured photosensitive resin material layer 24 is then developed to form the accommodation grooves 22.

As compared with the first implementation, in the second implementation, it only needs to perform exposure and development when forming the plurality of accommodation grooves 22 in the photosensitive resin material layer 24, but does not need to perform etching, thereby reducing processing steps and increasing manufacturing efficiency.

Specifically, a material of the prepolymer 23 may include any one of or a combination of more than one of methacrylate, epoxy acrylate, and silicone acrylate.

Further, a viscosity of the prepolymer 23 ranges from 4000 cps to 7000 cps, which facilitates instilling and curing the prepolymer 23. It should be understood that, an angle θ between a protruding surface formed by the prepolymer 23 and the horizontal plane may be adjusted by adjusting the viscosity of the prepolymer 23, so as to adjust the shape of the microlens unit, i.e., to change the focal length of the microlens unit.

Further, in the step of curing the prepolymer 23, the prepolymer 23 is cured by irradiation with ultraviolet (UV) light, so that the shape of the microlens unit is stable, as shown in FIG. 8.

After the colloidal prepolymer 23 is instilled into the accommodation grooves 22, the prepolymer 23 in each accommodation groove forms a protrusion structure whose top surface is a curved surface, and the center of the top surface is higher than the sidewall of the accommodation groove. Thus, in order to prevent the prepolymer 23 in an accommodation groove 22 from flowing to connect to the prepolymer in an adjacent accommodation groove 22 before being cured, the manufacturing method further includes, before the step of instilling the prepolymer 23 into each of the plurality of accommodation grooves (i.e., the step S3 in FIG. 2), a step of:
forming an opaque immiscible layer 26 on a top surface of the sidewall 221 of each accommodation groove, wherein the immiscible layer 26 is immiscible with the prepolymer 23. When instilling the prepolymer 23, the volume of each droplet of the prepolymer 23 is larger than that of each accommodation groove 22. Since the top surface of the sidewall of each accommodation groove 22 is provided with the immiscible layer 26, the prepolymer 23 will not adhere to the immiscible layer 26 when it drips down to the substrate, and will slide into the accommodation grooves 22. In such a way, the prepolymer 23 in an accommodation groove 22 is prevented from connecting to the prepolymer 23 in an adjacent accommodation groove 22, so as to form a plurality of separate microlens units. Thus, by providing the immiscible layer 26 on the top surface of the sidewall of each accommodation groove, it is ensured that the plurality of microlens units that are finally formed are separated from each other, thereby reducing the crosstalk among the microlens units and the light leakage of the microlens units in the microlens array when 3D imaging is performed, and improving the display effect.

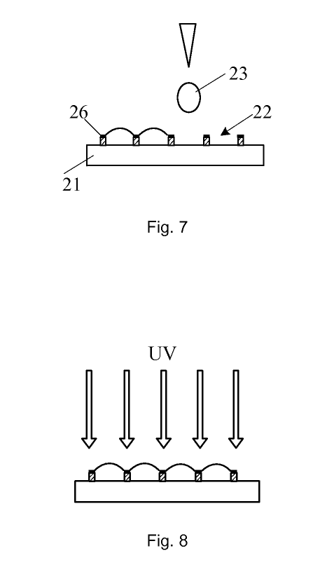

As shown in FIG. 6, black ink may be provided, as the immiscible layer 26, on the top surface of the sidewall 221 of each accommodation groove 22 by a transfer process. Specifically, a material for forming the immiscible layer 26 may include polystyrene and/or poly(silyl ester)s.

When the shapes of the accommodation grooves 22 are the same and the volumes of the prepolymer in the accommodation grooves 22 are the same, and the forces of interaction between the protruding surfaces formed by the prepolymer 23 in the accommodation grooves 22 and the immiscible layers 26 provided on the top surfaces of the sidewalls 221 of the accommodation grooves 22 are also the same, the shapes of the microlens units are the same, thereby forming a uniform microlens array. Since the prepolymer 23 itself has flowability, the focal length of the microlens unit may be changed by changing any one of the shape of each accommodation groove 22, the volume of the prepolymer 23 in each accommodation groove 22, and the force of interaction between the prepolymer 23 and the immiscible layer 26. Thus, with the manufacturing method provided by the present invention, microlens units having different shapes and different sizes can be obtained more easily.

The manufacturing method of a microlens array provided by the present invention has been described above. It can be seen that, in manufacturing the microlens array, a prepolymer is instilled into each of the accommodation grooves, each droplet of the prepolymer self-assembles to form a protrusion with a curved top surface due to the surface tension of the prepolymer, after being cured, the protrusion cannot flow anymore and can thus maintain a stable shape, in this way, the cured droplet of the prepolymer forms a microlens unit, and a plurality of the microlens units form a microlens array. When manufacturing a large-scale microlens array, the manufacturing method according to the present invention is more convenient, without manufacturing related moulds, and results in better precision and uniformity of the microlens array. Furthermore, the microlens array can be formed on a substrate (e.g., a glass substrate) of a display panel, thereby reducing the cost thereof.

As a second aspect of the present invention, there is provided a microlens array manufactured by the above manufacturing method. As compared with the method of forming a microlens array with a grinding tool in the prior art, the microlens array manufactured by using the manufacturing method according to the present invention has higher precision and uniformity. Specifically, the microlens array includes a substrate, a plurality of accommodation grooves formed on the substrate, and a plurality of microlens units provided in the plurality of accommodation grooves, respectively, each of the microlens units being polymer. It is easily understood for a person skilled in the art that, the polymer is formed by polymerizing the prepolymer.

Here, a material for forming the polymer includes any one of or a combination of more than one of methacrylate, epoxy acrylate, and silicone acrylate.

As described above, the substrate may be etched directly to form the accommodation grooves. Alternatively, a photosensitive resin material layer may be provided on the substrate, and exposure and development are performed on the photosensitive resin material layer to form the accommodation grooves.

Correspondingly, the substrate may include a substrate body, and the accommodation grooves are formed in the substrate body, so that the microlens array has a stable structure and a small thickness.

Alternatively, the substrate includes a substrate body, the photosensitive resin material layer is provided on the substrate body, and the accommodation grooves are formed in the photosensitive resin material layer. In this case, it only needs to perform exposure and development to form the accommodation grooves in the photosensitive resin material layer, but does not need to perform etching, thereby reducing processing steps and increasing manufacturing efficiency. Specifically, a material for forming the photosensitive resin material layer includes any one or a combination of trimethylolpropane triacrylate (simply referred to as TMPTA) and 2-Propenoic acid, 1,1′-[(1-methyl-1,2-ethanediyl) bis [oxy(methyl-2,1-ethanediyl)]] ester (simply referred to as TPGDA).

Further, the opaque immiscible layer is provided on the top surface of the sidewall of each accommodation groove. Thus, when the prepolymer is instilled into each of the plurality of accommodation grooves to form a microlens unit, the prepolymer in adjacent accommodation grooves will not flow to connect to each other, thereby reducing the phenomena of crosstalk and light leakage.

Specifically, a material of the immiscible layer includes polystyrene and/or poly(silyl ester)s.

As a third aspect of the present invention, there is provided an image acquisition device, which includes a camera and a microlens array provided on the camera, wherein, the microlens array is the microlens array provided by the present invention. The image acquisition device can acquire image information of an object from a plurality of directions through the camera and the microlens array, and transmit the image information to a display device for display. Since the microlens array of the present invention has better precision and uniformity, an image acquired by the image acquisition device including the microlens array is more accurate.

It should be understood that, the microlens array is provided on the lens of the camera, light enters into the microlens array before entering into the camera, and then enters into the lens of the camera after being refracted by the microlens array, i.e., what acquired by the camera is the image information resulting from the refraction by the microlens array.

As a fourth aspect of the present invention, there is provided a display device, which includes a display panel and a microlens array provided on a light-outgoing surface of the display panel, wherein, the microlens array is the microlens array provided by the present invention.

It should be understood that, the image source displayed by the display device provided by the present invention is acquired by the image acquisition device provided by the present invention. After acquiring the image information of an object, the image acquisition device transmits the image information to the display device, and the display device restores the image information to a 3D image through the microlens array provided on the light-outgoing surface of the display panel. The substrate of the microlens array and that of the display panel may be a same substrate (e.g., a glass substrate), thereby reducing the manufacturing cost.

It should be understood that, the above embodiments are only exemplary embodiments for the purpose of explaining the principle of the present invention, and the present invention is not limited thereto. For a person having ordinary skill in the art, various improvements and modifications may be made without departing from the spirit and essence of the present invention. These improvements and modifications also fall within the protection scope of the present invention.

1. A manufacturing method of a microlens array, including steps of:
providing a substrate;
forming a plurality of accommodation grooves on the substrate;
instilling a colloidal prepolymer into each of the plurality of accommodation grooves, so that a top surface of the prepolymer forms a curved surface protruding outwards; and
curing the prepolymer, so that the prepolymer in each of the plurality of accommodation grooves is cured to form a microlens unit, thereby obtaining the microlens array.

2. The manufacturing method according to claim 1, wherein, the step of forming a plurality of accommodation grooves on the substrate includes steps of:
forming a photoresist layer on the substrate; and
etching the substrate by a photolithographic patterning process, so as to form the plurality of accommodation grooves in the substrate.

3. The manufacturing method according to claim 1, wherein, the step of forming a plurality of accommodation grooves on the substrate includes steps of:
forming a photosensitive resin material layer on the substrate; and
performing exposure and development on the photosensitive resin material layer, so as to form the plurality of accommodation grooves in the photosensitive resin material layer.

4. The manufacturing method according to claim 1, further including, before the step of instilling a colloidal prepolymer into each of the plurality of accommodation grooves, a step of:
forming an opaque immiscible layer on a top surface of sidewall of each of the plurality of accommodation grooves.

5. The manufacturing method according to claim 4, wherein, a focal length of the microlens unit is changed by changing any one of shape of each of the plurality of accommodation grooves, volume of the prepolymer in each of the plurality of accommodation grooves, and force of interaction between the prepolymer and the immiscible layer.

6. The manufacturing method according to claim 4, wherein, a material of the immiscible layer includes polystyrene and/or poly(silyl ester)s.

7. The manufacturing method according to claim 1, wherein, a material of the prepolymer includes any one of or a combination of more than one of methacrylate, epoxy acrylate, and silicone acrylate.

8. The manufacturing method according to claim 7, wherein, a viscosity of the prepolymer ranges from 4000 cps to 7000 cps.

9. The manufacturing method according to claim 7, wherein, in the step of curing the prepolymer, the prepolymer is cured by irradiation with ultraviolet light.

10. The manufacturing method according to claim 3, wherein, a material of the photosensitive resin material layer includes any one or a combination of TMPTA and TPGDA.

11. A microlens array, including a substrate, a plurality of accommodation grooves formed on the substrate, and a plurality of microlens units provided in the plurality of accommodation grooves, respectively, each of the microlens units being polymer.

12. The microlens array according to claim 11, wherein, the substrate includes a substrate body, and the plurality of accommodation grooves are formed in the substrate body.

13. The microlens array according to claim 11, wherein, the substrate includes a substrate body, a photosensitive resin material layer is provided on the substrate body, and the plurality of accommodation grooves are formed in the photosensitive resin material layer.

14. The microlens array according to claim 11, wherein, an opaque immiscible layer is provided on a top surface of sidewall of each of the plurality of accommodation grooves.

15. The microlens array according to claim 14, wherein, a material of the immiscible layer includes polystyrene and/or poly(silyl ester)s.

16. The microlens array according to claim 11, wherein, a material of the prepolymer includes any one or a combination of more than one of methacrylate, epoxy acrylate, and silicone acrylate.

17. The microlens array according to claim 13, wherein, a material of the photosensitive resin material layer includes any one or a combination of TMPTA and TPGDA.

18. An image acquisition device, including a camera and a microlens array provided on the camera, wherein, the microlens array is the microlens array according to claim 11.

19. A display device, including a display panel and a microlens array provided on a light-outgoing surface of the display panel, wherein, the microlens array is the microlens array according to claim 11.
